(19) United States
(12) Patent Application Publication
(10) Pub. No.: US 2020/0306120 A1
(43) Pub. Date: Oct. 1, 2020

(54) TILTING MOBILITY SCOOTER DEVICE

(71) Applicant: Taylor Moreland, Centralia, MO (US)

(72) Inventor: Taylor Moreland, Centralia, MO (US)

(21) Appl. No.: 16/805,321

(22) Filed: Feb. 28, 2020

Related U.S. Application Data
(60) Provisional application No. 62/812,175, filed on Feb. 28, 2019.

(51) Int. Cl. A61H 3/04

(52) U.S. Cl. CPC A61H 3/04; A61H 2003/007; A61H 2201/1621

(57) ABSTRACT

Techniques are disclosed to enable a mobility device for a child with gross motor disabilities. The mobility device has a curved base platform of substantially rigid material having a chest support end, with sides attached to the base platform protruding up to form a cavity in the base platform to support the child's body. It also has two wheels rotatably attached to the base platform, the wheels bearing a majority of the child's weight, the wheels positioned sufficiently behind the chest support end so that the device tilts upward when the child pushes down with its arms, thereby lifting up the chest support end so that the child may crawl with assistance of the mobility device. Furthermore, the device has straps for securing the child in the cavity at the surface of the base platform.

### RELATED APPLICATIONS

The current U.S. non-provisional patent application claims priority benefit to all common subject matter of earlier-filed U.S. provisional patent application entitled “TILTING MOBILITY SCOOTER DEVICE”, Application Ser. No. 62/812,175, filed Feb. 28, 2019. The earlier-filed application is hereby incorporated by reference in its entirety into the present application.

### BACKGROUND

Mobility is an important part of physical and cognitive development for children, especially young children and infants. Many children achieve mobility first through crawling on the floor. Typically, an infant will learn to crawl between the ages of seven and ten months of age. When a child becomes able to crawl, he begins to explore his surroundings, becomes spatially aware, interacts with objects, achieves physical exercise, and perhaps most importantly gains a sense of independence. Children born with gross motor disabilities are frequently limited in terms of their mobility. Some children with gross motor disabilities may never be able to crawl on their own or may only be able to traverse very short distances by dragging their body across the floor. Child-sized wheelchairs can offer some mobility to these children when they are old enough, strong enough, and experienced enough to use them. However, wheelchairs are limiting for children in a home environment as they tend to be large and do not allow the child to reach the floor or maneuver as a crawling child does. There few viable devices that do assist children who have gross motor disabilities with floor mobility and with crawling efforts. Such devices are generally divided into two categories: scooter boards and crawling assistive devices.

Scooter Boards:

Scooter Boards are dolly-like devices consisting of a flat surface with caster wheels on the underside of the device. The user is laid chest down on top of the device. Often the user's appendages (head, arms and legs) extend beyond the surface of the device, and the weight of these appendages is not supported by the device. Some scooter boards are shaped in a way that the user's legs or head is supported by the surface of the device. The user is to use his arms and/or legs to maneuver the device and propel himself across a surface.

These devices have small caster wheels of generally less than three inches in diameter. These small caster wheels limit these devices to only be used on smooth surfaces, like hardwood or tile. Caster wheels are not easily maneuverable through thick carpeting. The small size of the wheels means that a high amount of force is required to roll through carpeting and the carpeting tends to impede the swivel mechanism needed to turn the caster wheels. Thus, turning and maneuvering scooter boards through carpeted surfaces becomes a challenge, especially for young children with gross motor disabilities.

Scooter boards are designed so that all wheels remain in contact with the floor at all times thus fixing the height of the scooter board relative to the floor. This fixes the height of the user's body from the floor to the same height of the scooter board from the floor. It is impossible for the user to bring his upper body and chest closer to the floor in order to interact with certain objects on the floor. Some scooter boards require that the user is strapped to them. In this case, if a user wants to push his upper body up away from the floor, he has to have enough strength to lift half his body weight plus part of the weight of the scooter board off of the floor. Users may use scooter boards without being strapped to them, but if the caster wheels were to get stuck, or if the force required to propel the scooter board were greater than the friction between the user and the scooter board, then the user would likely push himself off the scooter board.

Scooter boards have wheels at each corner, typically in close proximity to where the users must place their hands when thrusting themselves forward. This wheel placement creates a high probability that a user will get his hands and/or fingers caught under one of the wheels, potentially inflicting pain and causing bodily harm to the user. The probability of this happening is increased when the user initiates a turn. To minimize the risk of this happening the user is required to use shorter strokes or strides when maneuvering the device, thus limiting the speed and force that they are able to apply to moving forward.

Most scooter boards are designed so that the user's head and neck extend beyond the surface of the board. This means that the user must hold his head up but has freedom to look around. Over time, the user's neck muscles will become exhausted from holding his head up, and he will need to rest his head. When the user attempts this, the head will hang over the edge of the board. This can be extremely uncomfortable and unnatural for the user and limits the amount of time the user is comfortably able to use a scooter board to typically a few minutes at a time.

As previously stated, these devices keep the user's entire body weight supported at a fixed height. Since the user is not required to support any of his body weight while using the device, he will not receive a meaningful amount of strength and coordination building that would be important for physical therapy.

Crawling Assistive Devices:

Crawling Assistive Devices typically consist of a large frame made of two upside down u-shaped poles connected perpendicularly to each other that arch over the user. A sling attached to the frame hangs underneath it and supports the user's chest and abdomen above the ground while leaving their arms and legs free to touch the floor. Caster wheels are attached to the bottom of the frame and allow it to roll across the floor. Some crawling assistive devices are designed for the user to lay on their chest, abdomen, and possibly head on top of the frame, analogously to scooter boards, while still leaving the user's arms and legs free to touch the floor. Caster wheels are also mounted to the bottom of these devices. The user is able to use his arms and legs to propel himself and the crawling assistive device across the floor.

The user's arms and legs are in contact with the floor while operating these devices. Users who are unable to use their lower body to assist in mobility will have difficulty using a crawling assistive device. If a user has no lower body function, their legs will drag on the floor while they use their upper body to pull themselves and maneuver the device. This will tremendously decrease their mobility, if not actually render them immobile.

The large frames of crawling assistive devices do not allow the user to maneuver close to objects of interest, since the frame will likely extend beyond the user's reach. This decreased the user's ability to reach objects and places of interest or maneuver the device through doorways or in an area with a number of obstacles. Crawling assistive devices tend to have small caster wheels like scooter boards. These small caster wheels have the same drawbacks as the small caster wheels on scooter boards. The devices are difficult to maneuver on thick carpet and may be limited to use on smooth surfaces.

Crawling assistive devices do not allow for a full range of motion in the user's upper body. The device holds the user's upper body at a fixed height above the ground, if the user were to pull their arms into their chest, their upper body would hang in the sling above the floor, or rest on the device above the floor. Users are only able to use these devices for a short period of time since they are unable to rest their head while using the device. If they do relax their neck to rest their head, then their head will dangle in and unnatural and uncomfortable position above the floor. Accordingly, it would be desirable to provide devices that overcome the deficiencies of crawling assistive devices and scooter boards discussed above.

### SUMMARY

Mobility devices are disclosed to provide floor mobility and physical therapy to children with gross motor disabilities. The mobility device has a curved base platform of substantially rigid material having a chest support end, with sides attached to the base platform protruding up to form a cavity in the base platform to support the child's body. It also has two wheels rotatably attached to the base platform, the wheels bearing a majority of the child's weight, the wheels positioned sufficiently behind the chest support end so that the device tilts upward when the child pushes down with its arms, thereby lifting up the chest support end so that the child may crawl with assistance of the mobility device. Furthermore, the device has straps for securing the child in the cavity at the surface of the base platform.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWINGS

The figures described below depict various embodiments of the present invention. It is understood that these figures depict exemplary embodiments. The exemplary features illustrated in the figures are intended to represent these aspects of the various disclosed embodiments and not intended to limit the claimed scope to any particular feature. Further, whenever possible, the following description refers to the reference numerals included in the figures, in which features depicted in multiple figures are designated with consistent reference numerals.

FIG. 1 is a perspective view of a mobility device consistent with the present teachings;

FIG. 2 is an exploded perspective view of a mobility device consistent with the present teachings;

FIG. 3 is a front perspective view of a mobility device consistent with the present teachings as being used;

FIG. 4 is a rear perspective view of a mobility device consistent with the present teachings as being used; and

FIG. 5 is an additional a perspective view of a mobility device consistent with the present teachings.

### DETAILED DESCRIPTION

The following text sets forth a detailed description of numerous different embodiments. However, it is understood that the detailed description is to be construed as exemplary only and does not describe every possible embodiment since describing every possible embodiment would be impractical. In light of the teachings and disclosures herein, numerous alternative embodiments may be implemented.

It is understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

The following detailed description of the technology references the accompanying drawings that illustrate specific embodiments in which the technology may be practiced. The embodiments are intended to describe aspects of the technology in sufficient detail to enable those skilled in the art to practice the technology. Other embodiments may be utilized and changes may be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology may include a variety of combinations and/or integrations of the embodiments described herein.

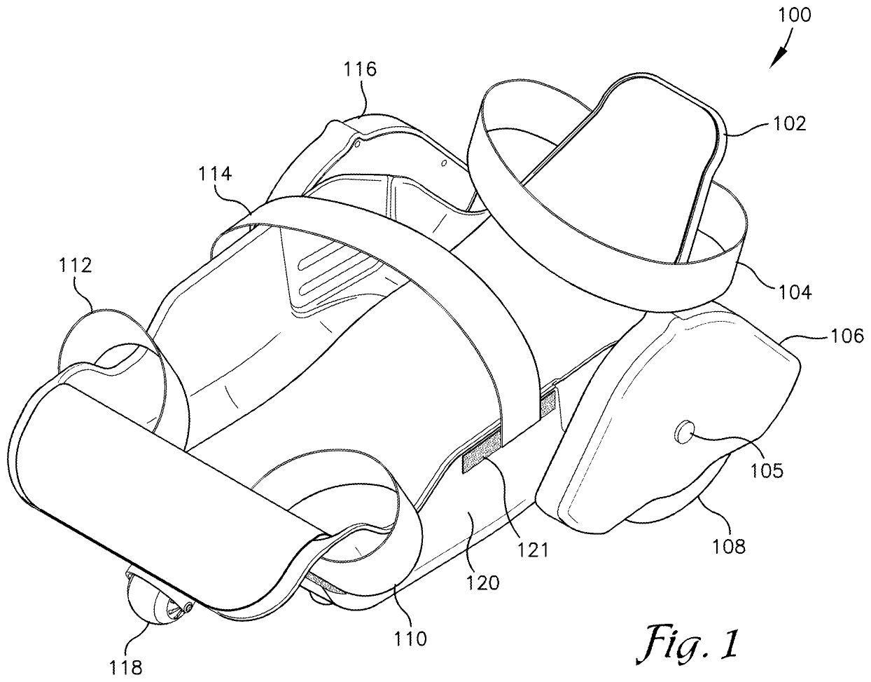

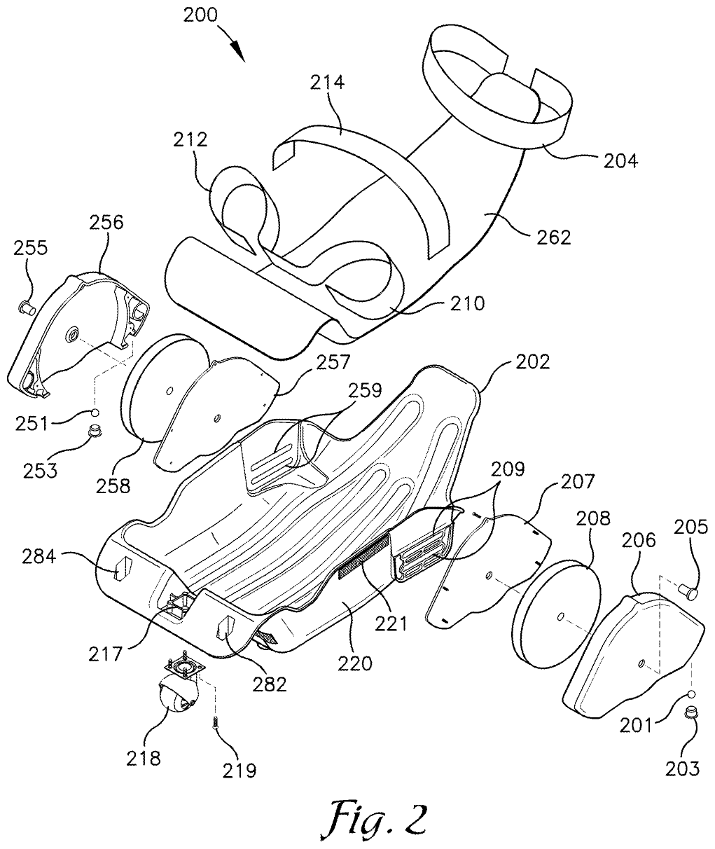

FIG. 1 is a perspective view of a mobility device 100 consistent with the present teachings. An embodiment includes a lightweight frame or body 120 which the user lays upon their front-side with the user's chest being supported by a chest support portion 102. The user's lower body and torso are supported by the frame 120 of the device with their arms and head extending outside the frame of the device. Two large wheels, including right wheel 108, are attached to axles, including axle 105, at the sides of the device above the lower frame and close to the user's hips, these wheels carry the majority of the user's weight. The remaining weight of the user is carried by the user's upper body. In various embodiments, the axles of the large wheels are capable of being moved forward or backward and locked into position. This allows for the ability to adjust the amount of the user's weight that is carried by the device and the amount of the weigh that is carried by the user. This adjustment is further described in connection with FIG. 2 below.

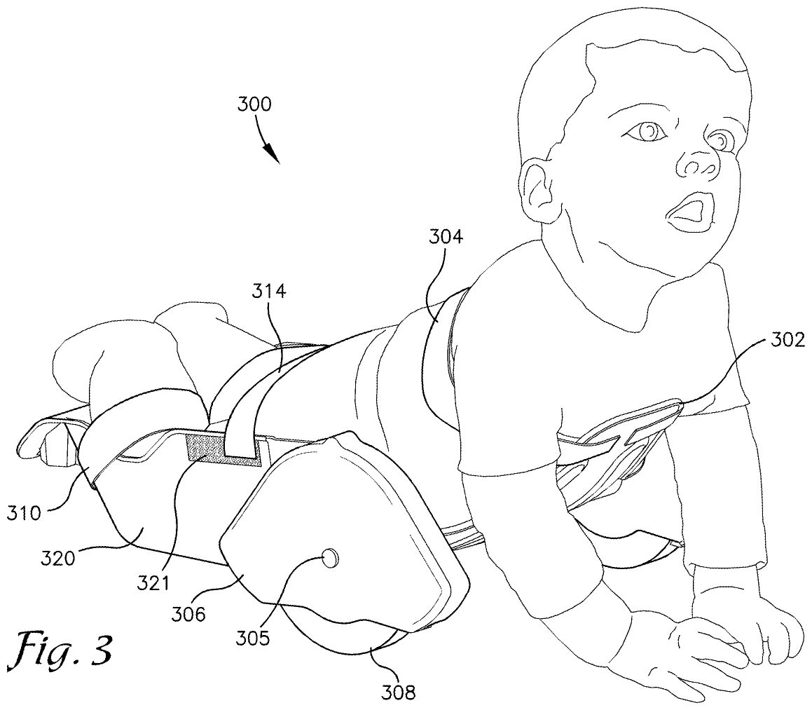

In various embodiments, right wheel guard 106 covers the right wheel 108 and protects the user's hand from being run over or pinched by the wheel 108. The wheel guard 106 is free to rotate about the axle 105. Left wheel guard 116 functions similarly albeit on the opposite (left) side of the device. Straps 104 and 114 are used to strap the user's chest and torso respectively into the device. Strap portions 110 and 112 of the leg strap are used to strap the user's right and left legs into the device respectively. In various embodiments, hook-and-loop type touch fasteners such as Velcro fastener 121 are used to fasten the straps to the device. It is understood that fasteners other than Velcro can be employed without departing from the present teachings. In various embodiments, caster wheel assembly 118 is employed at the back of the device when the user is actively crawling as further described in connection with FIG. 3 below.

FIG. 2 is an exploded perspective view of a mobility device 200 consistent with the present teachings. In various embodiments, main body 220 is made of lightweight rigid material, such as one-quarter inch thick PVC plastic, including chest support portion 202. It is understood that various other materials now known or hereinafter developed may be employed without departing from the present teachings as well as the use of materials of varying thicknesses. The rigid material is formed into the appropriate three-dimensional shape to form the body of the device, by way of bending, molding, welding or any other appropriate method. The body of the device comprises multiple flat surfaces adjoined (or formed) together. The curved lower platform or body 220 of the device on which the user lays their body is made up of multiple flat surfaces attached (or formed) together at various angles to form one continuous surface, of these surfaces are the breastplate (chest support portion), the abdomen plate, the leg plate, the shin plate, and the foot plate, designated based on which part of the user's body is in contact with the surface portions of the body 220. In various embodiments, the foot plate is angled downward from the rear of the device as illustrated in the figure. A caster wheel mounting plate 217 is located underneath of and attached to the foot plate and the shin plate and is centered between the right and left sides of the device. A caster wheel assembly 218 is mounted with caster wheel mounting screws 219 to the caster wheel mounting plate 217. In various embodiments, a ball type caster is used in connection with the caster wheel assembly 218. In various embodiments, side plates are attached on (or formed with) each side of the curved lower platform mounted flush to the convex side of the curved lower platform extending vertically from the concave side of the curved lower platform, preferably at a right angle to each of the surfaces that make up the curved lower platform, except for the foot plate. In various embodiments, axle slots 209 and 259 are milled into the side plates above the abdomen plate. In various embodiments, sliding axle brackets are pressed into the axle slots from the inside of the device.

In various embodiments, the large center wheels 208 and 258 for the device are made of rigid material and in different embodiments will vary in size, preferably but not limited to PVC plastic, approximately six inches in diameter. The hubs of the large wheels are large enough to accommodate axles and axle components 205 and 255. In various embodiments, the axle length is determined by the side plate and wheel thickness. The axles are inserted through the large wheels, through the axle slots in the side plates of the device and inserted into and attached to the axle slots 209 and 259. As shown in FIG. 2, there are two slots each 209 and 259, but it is understood that there could be more slots provided such as, for example, three or four, which would allow the axle to be mounted higher or lower depending on which slot is selected. Moreover, depending on how far forward or backward the axle is mounted determines the length of the fulcrum about which the device pivots at the wheels. In this way, the pivot point determined by the wheel positions can be configured based on the weight and other physical characteristics of a particular user. Wheel guards 206 and 256 are retained by axles 205 and 255, including their respective wheel guard backs 207 and 257. In various embodiments, as explained in connection with FIG. 1 above, the wheel guards 206 and 256 are free to move and rotate independently from the wheels 208 and 258. Typically, when the user is crawling and the device is rolling forward, a front portion of the wheel guards 206 and 256 will be in contact with the floor. In various embodiments, an optional roller device at the front of the wheel guards is in contact with the floor to prevent scratching the floor and otherwise to reduce friction during the operation of the device. In various embodiments, this roller device is implemented by way of balls 201 and 251, which are retained by ball retainers 203 and 253.

In various embodiments, straps are attached to the device in a number of areas to secure the user to the device during operation. In various embodiments, the straps are made out of any suitable lightweight flexible material and secured to the device using any securing method that provides a strong enough hold to secure the user to the device, such as Velcro fastener 221 shown in the figure. Exemplary locations that straps may be secured to the device in various embodiments are as follows: the underside of the breastplate on both the right and left sides, i.e. exemplary strap 204, the top of the side plates on either the inside or outside behind the large wheels on both the right and left sides, i.e. exemplary strap 214 to either the top or bottom of the shin plate on the center, right, and left side (strap portions 212 and 210), or any other location for which a strap would be beneficial to the user. In various embodiments, a padding layer 262 is provided for the comfort of the user.

Once the user is positioned in such a way and strapped onto the device, the positioning of the large wheels is adjusted to achieve the appropriate weight balance for the user. In some embodiments, the large wheels are positioned to carry the majority of the user weight and the device weight, while the remaining weight is carried by the user's arms in order to control the device. The positioning of the large wheels is highly customizable due to the device featuring multiple axle slots in which the axles of the large wheels may be positioned. To adjust the positioning of the large wheels the axle brackets are loosened then slide into the correct position along the axle slots and tightened. To put more of the user's body weight onto the device the axle brackets are moved forward toward the user's head. To put more of the user's body weight onto the user's arms, the axle brackets are moved backward toward the user's feet. The height of the device is capable of being adjusted by removing the axles from their current axle slot and inserting them into a different axle slot above or below the previous slot. To provide any necessary counterbalance, additional weight, e.g. in the form of steel bolts can be added to the weight pockets 282 and 284. It is understood that any kind of weight could be added to the pockets to achieve the desired degree of counterbalance.

In some embodiments, repositioning of the axles and large wheels is done by a second individual, while the user is on the device. Repositioning the large wheels is possible multiple times as the user grows, becomes stronger, and/or more experienced with using the device. The unique design of the multiple axle slots located in the side plates of the device makes customizing the position of large wheels easy to accomplish. Once the correct large wheel position for the user is achieved, the user will be ready to use the device for mobility.

The user is able to achieve mobility while operating the device using only their arms. Using similar techniques that a child would use to push their chest up, or side to side while laying on the floor, a user is able to achieve mobility with the device. In addition to allowing the device to roll, the axles of large wheels act as a fulcrum for the tilting feature of the device. With no effort exerted, the user is in resting position with the user's chest, head, and arms resting on the floor along with the breastplate. In this resting position the back of the device is in an elevated position with the user's lower body resting upon it. When the user pushes against the floor with their arms they bring the breastplate and their chest off of the floor and bring the device into active position. The device tilts along with the user's body with the axles of the large wheels acting as the fulcrum so that the user's lower body and rear of the device tilts down as the user's chest and front of the device tilt up. When the user fully extends their arms while pushing against the floor, the caster wheel 218 at the rear of the device comes into contact with the floor preventing the device from tilting any further. The user is able to maneuver the device with or without the caster wheel being in contact with the floor. The user is able to use their arms to propel themselves and the device forwards or backwards, or turn the device left or right by pushing in the opposite direction against the floor in much the same way that a child would using their arms while crawling. When the axle brackets and weight distribution is adjusted properly, the user is able to use one arm to hold their chest off of the ground so that they are able to use their other arm and hand to interact with objects around them. The user is also able to bend their arms and rest their elbows on the floor, slightly tilting the device and leaving both hands free to manipulate objects. When the user relaxes their upper body, the device tilts so that the breastplate and the user's chest again rests on the floor, with the rear of the device and the user's lower body in an elevated position.

Mobility in the device is very simple and intuitive for the user to achieve. The weight that is distributed to the user's arms while using the device closely resembles the weight that a typical child experiences on their arms while crawling. This weight is capable of being adjusted to the user's strength level by use of the axle brackets, from barely any weight to nearly half of the user's body weight. This variable weight distribution allows for users with a wide variety of strength levels and gross motor function disability levels to use the device. The large wheels in the center of the device allow the user to traverse across many different surface types, from smooth flooring to thick carpeted flooring, and over small obstacles such as rugs or flooring transitions.

These large wheels also allow the user to maneuver the device with a small amount of effort, allowing for users to use the device to traverse relatively long distances without fatigue. The center positioning of the wheels ensures that the user has a low risk of getting a finger or hand caught or pinched underneath a wheel. The height positioning of the wheels gives the device a high clearance so that the user is able to maneuver over obstacles such as small toys. The tilting feature of the device provides a full range of motion throughout the user's upper body so that they are able to interact with objects above their head and on the floor level while using the device. Additionally, the tilting feature allows for the user to rest by laying their head, neck, arms, and chest on the floor without exiting the device. This feature combined with previously stated features allows for this device to be used comfortably over an extended period of time.

FIG. 3 is a front perspective view of a mobility device 300 consistent with the present teachings as being used. In various embodiments, the frame 320 of the device is curved upward in front, beyond the large center wheels, forming chest support portion 302. In addition to providing mobility and enabling the device to roll forward, backward, and to pirouette and turn, the large wheels, including right wheel 308, act as a fulcrum for the tilting feature of the present teachings. In particular, when the user exerts no effort then the device will be tilted forward with the back of the device off the ground and the front of the device on the floor, so that the users hands are in contact with the floor so the user can crawl. The user will be in a resting position with their head, chest, and arms on the floor, and lower body resting on the device in a slightly elevated position. When the user uses their arms to push their chest off the floor, the device tilts so that the front of the device comes up with the user's chest, which is strapped against chest support 302 with chest strap 304. The user's lower body is also strapped in with pelvis strap 314 (at Velcro fastener 312) and the legs with leg strap 310. With the user's chest off the floor, the user is able to use his arms to propel the device and the user across the floor forward and backward and to turn the device.

This tilting mechanism allows the user to be mobile on the floor using their arms for self-propulsion, while having a full range of motion in their upper body, from resting on the floor through arm extension of the user. The two large wheels allow the user to propel the device over small obstacles, or surfaces that are not smooth, such as thick carpeting. The positioning of the large wheels gives the device clearance to allow the user to straddle small obstacles. There are no wheels in the front of the device where the user's hands are located, so there is very little risk of the user getting a hand or finger pinched under a wheel while maneuvering the device. Moreover, in various embodiments, independently rotatable wheel guard 306 provides further protection to the user's hand and is held in place by axle 305.

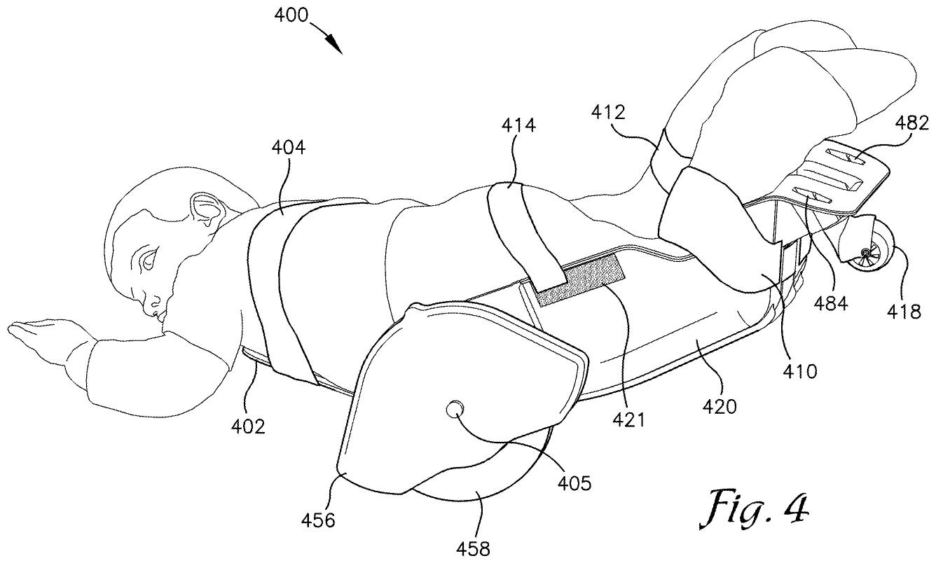

FIG. 4 is a rear perspective view of a mobility device 400 consistent with the present teachings as being used. Typically, a user begins to use this device at the age that a baby would typically be learning to crawl. This age varies from user to user, but typically starts as early as six months. There is no maximum age at which a user must quit using the device. This depends upon size of the user and size of the device, as some embodiments of the device are made larger for larger users. This device is designed to be used primarily for casual in-home floor mobility and is capable of being used for extended periods of time on a daily basis. A secondary use of the device is for physical therapy purposes of the user. Such physical therapy uses include but are not limited to upper body strength conditioning, balance development, and coordination development.

In order to use this device, the user is placed in a chest down laying position into the device. In some uses another individual helps the user into the device. The user is positioned so that their knees are rested in the area where the shin plate and leg plate meet, with their knees bent, shins resting on the shin plate of the device and feet elevated and extending past or resting on the foot plate. The user's upper portion of legs, pelvis and torso lay on the device, and follow the curvature of the device. The user's chest typically is resting on the front of the breastplate 402 which extends past the large center wheels and is part of the overall device body 420. The user is positioned in such as way so that the breastplate 402 supports the user's entire chest while not supporting the user's neck, head, or shoulders. The user's arms extend out past the edge of the device in such a way so that the user has a full range of motion with their arms without interference of the device. The user's head and neck extend past the front edge of the device, in the same way as the arms, so that they have a full range of motion with their head.

In some embodiments, strapping a user into the device is beneficial. The straps used in some embodiments are one or more of the chest strap 404, pelvis strap 414, and leg straps 410, 412. The chest strap 404 attaches to the underside of the breastplate directly below to the user's chest. It runs through the user's armpits and over the user's back to secure the user's chest to the breastplate 402. The pelvis strap 414 attaches to the side plates at Velcro fastener 412 and runs over the user's pelvis region in order to secure the user's pelvis to the curved lower platform. The leg straps 410, 412 attach to the shin plate and run over the user's calves in order to secure the user's shins to the shin plate. The leg straps are especially useful when the device is tilted downward with shin plate in an elevated position. Left wheel 458 is protected by wheel guard 456, both of which are connected to the body 420 by way of axle 405. As shown, the device is tilted forward so that caster wheel assembly 418 is not in contact with the floor, and balance can be optimized in connection with weight pockets 482 and 484.

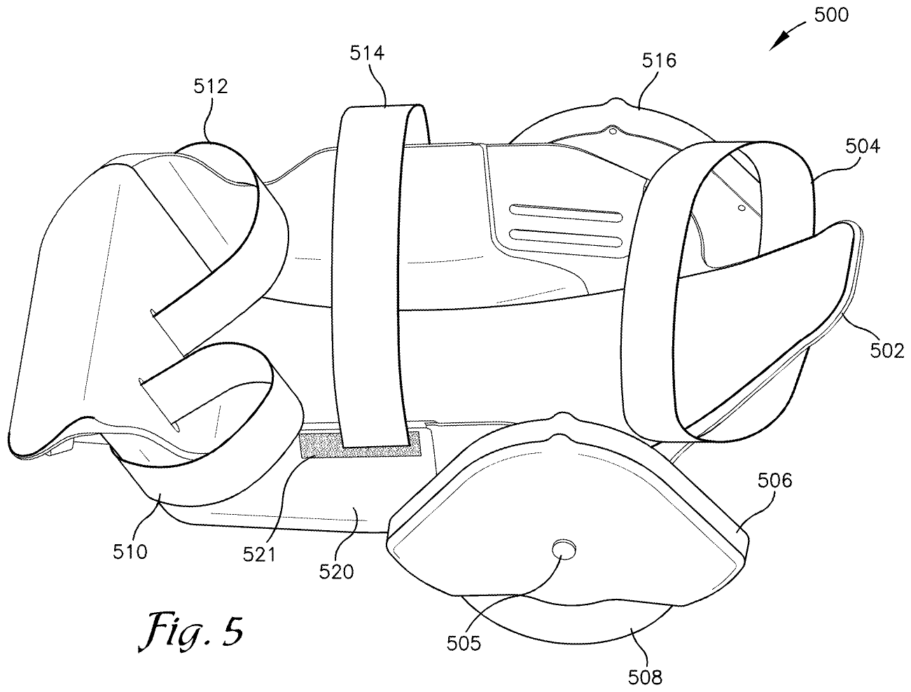

FIG. 5 is an additional a perspective view of a mobility device 500 consistent with the present teachings. In various embodiments, integrated body 520 is provided onto which the user lays upon their front-side, with the user's chest being supported by chest support portion 502. The user's lower body and torso are supported by the body 520 of the device with their arms and head extending outside the frame of the device. A large wheel 508 is attached to an axle 505, at the side of the device above the lower part of the body and close to the user's hips, these wheels carry the majority of the user's weight. The remaining weight of the user is carried by the user's upper body, when the user is, for example, crawling with the device. In various embodiments, the axle 505 is capable of being moved forward or backward and locked into position. This allows for the ability to adjust the amount of the user's weight that is carried by the device and the amount of the weigh that is carried by the user. This adjustment is further described in connection with FIG. 2 above.

In various embodiments, wheel guards 506 and 516 cover the wheels of the device, including wheel 108 and protects the user's hand from being run over or pinched by the wheel 508. The wheel guard 506 is free to rotate about the axle 505. Straps 504 and 514 are used to strap the user's chest and torso respectively into the device. Strap portions 510 and 512 of the leg strap are used to strap the user's right and left legs into the device respectively. In various embodiments, fasteners such as Velcro fastener 521 are used to fasten the straps to the device. It is understood that fasteners other than Velcro can be employed without departing from the present teachings. In various embodiments, a caster wheel assembly (not shown) is employed at the back of the device when the user is actively crawling as further described in connection with FIG. 3 above.

Having thus described various embodiments of the technology, what is claimed as new and desired to be protected by Letters Patent includes the following:

What is claimed is:

1. A mobility device for a child with gross motor disabilities, the mobility device comprising:
a curved base platform of substantially rigid material having a chest support end, with sides attached to the base platform protruding up to form a cavity in the base platform to support the child's body;
two wheels rotatably attached to the base platform, the wheels bearing a majority of the child's weight, the wheels positioned sufficiently behind the chest support end so that the device tilts upward when the child pushes down with its arms, thereby lifting up the chest support end so that the child may crawl with assistance of the mobility device; and
at least one strap adapted to secure the child in the cavity at the surface of the base platform.

2. The mobility device of claim 1 further comprising first and second axles attached to the sides with the first axle being on the opposite side of the second axle across base platform.

3. The mobility device of claim 2, wherein a position of the first and second axles can be adjusted forward and backward with respect to the chest support end.

4. The mobility device of claim 2, wherein a position of the first and second axles can be adjusted up and down with respect to the chest support end.

5. The mobility device of claim 3 further comprising wheel guards that rotate independently from the base platform.

6. The mobility device of claim 5 further comprising at least one friction-reducing roller ball at a front portion of the wheel guards.

7. The mobility device of claim 1 further comprising a swivel caster rotatably affixed to an underside of the base platform opposite the chest support end.

8. The mobility device of claim 7 further comprising weight pockets adapted to receive weights to counter-balance the mobility device.

9. A mobility device for a child with gross motor disabilities, the mobility device comprising:
a curved base platform of substantially rigid material having a chest support end, with sides attached to the base platform protruding up to form a cavity in the base platform to support the child's body;
first and second axles attached to the sides with the first axle being on the opposite side of the second axle across base platform, wherein a position of the first and second axles can be adjusted forward and backward with respect to the chest support end;
two wheels rotatably attached to the base platform by the first and second axles, the wheels bearing a majority of the child's weight, the wheels positioned sufficiently behind the chest support end so that the device tilts upward when the child pushes down with its arms, thereby lifting up the chest support end so that the child may crawl with assistance of the mobility device; and
at least one strap adapted to secure the child in the cavity at the surface of the base platform.

10. The mobility device of claim 9 further comprising wheel guards that rotate independently from the base platform.

11. The mobility device of claim 10 further comprising at least one friction-reducing roller ball at a front portion of the wheel guards.

12. The mobility device of claim 9 further comprising a swivel caster rotatably affixed to an underside of the base platform opposite the chest support end.

13. The mobility device of claim 12 further comprising weight pockets adapted to receive weights to counter-balance the mobility device.

14. The mobility device of claim 9 further comprising a padding layer.

15. The mobility device of claim 9, wherein the substantially rigid material comprises polyvinyl chloride (PVC) plastic.

16. A mobility device for a child with gross motor disabilities, the mobility device comprising:
a curved base platform of substantially rigid material having a chest support end, with sides attached to the base platform protruding up to form a cavity in the base platform to support the child's body;
first and second axles attached to the sides with the first axle being on the opposite side of the second axle across base platform, wherein a position of the first and second axles can be adjusted forward and backward with respect to the chest support end;
wheel guards that rotate independently from the base platform, the wheel guards having at least one friction-reducing roller ball at a front portion of the wheel guards;
two wheels rotatably attached to the base platform by the first and second axles, the wheels bearing a majority of the child's weight, the wheels positioned sufficiently behind the chest support end so that the device tilts upward when the child pushes down with its arms, thereby lifting up the chest support end so that the child may crawl with assistance of the mobility device;
at least one strap adapted to secure the child in the cavity at the surface of the base platform; and
a swivel caster rotatably affixed to an underside of the base platform opposite the chest support end.

17. The mobility device of claim 16 further comprising weight pockets adapted to receive weights to counter-balance the mobility device.

18. The mobility device of claim 16 further comprising a padding layer.

19. The mobility device of claim 16, wherein the substantially rigid material comprises polyvinyl chloride (PVC) plastic.

20. The mobility device of claim 16, wherein the strap is removably affixed to the base platform with a hook-and-loop type touch fastener.
